(19) United States
(12) Patent Application Publication
(10) Pub. No.: US 2003/0108843 A1
(43) Pub. Date: Jun. 12, 2003

(54) Articulator device and method of using the same

(76) Inventors: Jack J. Tucker, San Antonio, TX (US); David A. Tucker, Houston, TX (US)

Correspondence Address: David A. Tucker, c/o Dr. Jack J. Tucker, 10306 Kings Grant Dr., San Antonio, TX, 78230, US

(21) Appl. No.: 10/341,569

(22) Filed: Jan. 13, 2003

Related U.S. Application Data
(63) Continuation of application No. PCT/US01/22558, filed on Jul. 17, 2001.
(60) Provisional application No. 60/218,967, filed on Jul. 17, 2000.
(60) Provisional application No. 60/224,959, filed on Aug. 11, 2000.
(60) Provisional application No. 60/233,562, filed on Sep. 19, 2000.
(60) Provisional application No. 60/238,509, filed on Oct. 6, 2000.

(51) Int. Cl. A61C 19/00

(52) U.S. Cl. 433/53; 433/34; 264/19

(57) ABSTRACT

An articulator for adjusting and fabricating a dental restoration has a proximal counter, occlusal counter and laboratory die. The method of using the articulator provides an accurate, extraoral adjustment of the dental restoration.

### CROSS REFERENCE TO RELATED APPLICATIONS

This application is a continuation-in-part of PCT Patent Application Serial Number PCT/US01-1000 filed Jul. 17, 2001, which claims the benefit of Provisional Application Serial No. 60/218,967, filed Jul. 17, 2000; Provisional Application Serial No. 60/224,959, filed Aug. 11, 2000; Provisional Application Serial No. 60/233,562, filed Sep. 19, 2000; Provisional Application Serial No. 60/238,509, filed Oct. 6, 2000; Provisional Application No. 60/315,630, filed Jun. 4, 2001.

### BACKGROUND OF INVENTION

Crowns are artificial porcelain, ceramic, or metal replacements of part or all of the anatomical crown of a tooth. Inlays and onlays are crowns that cover primarily either the side or top, respectively, of the tooth. Crowns protect weak teeth from breakage, restore cracked teeth, stabilize teeth unable to hold a large filling, cover dental implants, support dental bridges, or cover badly shaped or discolored teeth. A dental bridge is essentially a few crowns joined together to replace missing teeth, whereas anterior veneer facings are prosthetic reconstructions of the front face of teeth. Dentures are false teeth.

The processes for making and adjusting crowns, bridges, inlays, onlays, dentures, and anterior veneer facings are essentially similar. The technician must cast from dental stones or plasters a dental working model, which is a precise duplication of the patient's mouth, on which the prosthesis is fabricated. The working model enables the dental technician to achieve accurate alignment and visual uniformity of the repaired tooth or teeth with the patient's other teeth. This dental cast model typically comprises an upper maxilla jaw model and a lower mandible jaw model affixed by an articulator.

An articulator is a device comprising upper and lower mounting platforms that are connected to the upper and lower jaw model elements. The articulator usually enables for centric, lateral and protrusive movement of the upper jaw model relative to the lower jaw model. Its purpose is to closely simulate the relationships and the actual movement, or bite, of the mouth of the patient. One well-known articulator was formerly sold under the U.S. Registered Trademark, VERTICULATOR® and is generally shown and described in U.S. Pat. No. 3,059,336.

Various types of devices and procedures have been used in the art for creating a dental cast model. A well-known and commonly used method for manufacturing dental cast models involves a molding process. The dentist takes impressions by having the patient bite into a pliant creamy or viscous material contained in one or more plastic trays, and sends it to the dental laboratory. Typically, the material used to make the impression is a rubber-like silicone impression material, a malleable compound or a wax-type material. The material is cured to create a mold cavity having a negative impression of the patient's arch or arches, reflecting the anatomy of the patient's teeth and gums. These impression materials are highly accurate, but they are expensive, voluminous, difficult to control, require careful handling, take time to cure, are easily distorted by jaw, cheek or tongue movements during the curing process, generate a considerable amount of flash, and are generally unpleasant for the patient.

The dental laboratory uses the impression to make a dental cast model by pouring dental stones, plaster, plastics, epoxy materials and/or other hardening material into the impression. The modeling materials used are semi-liquid when cast but hard when cured. When the impression sets, a model of the entire quadrant of the patient's teeth and gums containing the restoration area is formed. The impression tray is then inverted and mounted upon a mounting device such as a dental cast tray or base. This dental cast tray or base is configured to fit into an articulator by various means. After the casting material hardens, the impression tray is removed so that the casting material forms a positive duplication of the teeth on the mounting surface. This process is repeated to produce a cast model of the opposing arch. The mounting devices are fitted into the articulator by various means.

To facilitate prosthesis development, the replica of the tooth or teeth to be restored and the adjacent tooth structures in the cast model must be separately severed or “sectioned” from the remainder of the dental model. This produces a “die” or model duplication of only a tooth or a span of a few teeth. The ability to remove each individual model tooth from its spatial physical relationship to the remainder of the jaw model helps the dental technician construct accurate margins, contours, proximal contacts, and occlusal contacts. It also enhances visibility and access to the part of the model representing the patient's preparation (i.e., the tooth structure on which the restoration will be seated).

It is essential that the dental technician be able to repeatedly remove the sectioned dies and reattach them to the rest of the working model segments precisely. Upon reattachment, the dies must precisely duplicate the original positioning prior to any cutting, separations or disassembly of the jaw model. If not, the laboratory's work product will be inaccurate.

To facilitate the severing of the model in such a way as to permit the dies to be returned to their original position, the teeth to be restored and the model teeth that are adjacent to the preparation are typically made with tapered, metal dowel pins (or “die pin”) projecting from the inferior surface of the die. This is usually done in a two-step process during the casting of the model. First, the knurled ends of a series of dowel pins are positioned in the inferior uncured stone material so that it corresponds to the damaged tooth/teeth and the adjacent structures. The tapered ends stick out of the bottom of the stone. The stone material in the mold is allowed to harden to a certain degree, upon which a release spray coating is applied evenly over the exposed surface. Alternatively, wax may be placed between the base and the dental model and around the tapered portion of the dowel pins. Instead of curing the stone around the die pins, technicians sometimes cure the stone and then use a Pindex machine to drill die pinholes. The pins are then inserted and affixed with cyanoacrylate.

Once the casting of the gum and teeth has hardened, the cured and lubricated dental model is positioned adjacent an uncured dental model base which is held in a dental base mold. The tapered portion of the dowel pins protruding from the dental model are positioned in the uncured dental model base which subsequently cures. To section the individual model segments from the remainder of the dental model, the entire jaw model is typically removed from the mounting device and positioned upon a cutting surface. A cutting device, such as a saw, can then be used to separate the desired model teeth from the remainder of the dental model. The sectioned cast model can then be reassembled for use. Now, the technician can selectively remove and replace the adjacent teeth and prepared tooth from the sectioned dental cast model when fabricating the restoration.

After the dentist receives the manufactured permanent restoration from the laboratory, usually several days to a week after the initial impression was taken, the permanent restoration is tested in the mouth to determine form, fit, and suitability. Because one or more prepared teeth, proximal teeth, or occluding teeth or the entire arch has typically shifted between the impression appointment and the seating appointment—or because the laboratory has made errors—the dentist usually must drill away at the mesial, distal and occlusal faces of the restoration, or even the adjoining or opposing teeth themselves, to ensure good proximal fit and good occlusion.

The current method of adjusting the fit of dental restorations is ancient. In an iterative process, the dentist applies a marking substance to the restoration's proximal faces, attempts to insert the restoration in the mouth, removes it, and uses an abrasive disk to grind away the burnished or bare spots shown on the marking material. Once sufficient material is removed to enable the crown to be seated on the preparation, proximal contact point tension is tested by how easily dental floss can be passed over the contact point. Occasionally, the restoration is seated with so much tension in the incorrect location that the dentist accidentally chips the porcelain surface of the crown when he either places it on, or attempts to remove it from, the preparation. The size and shape of the proximal contact area is tested by partially looping dental floss around the contact point, bringing the ends together, pulling them parallel to each other, and inspecting the distance between the strands at different angles relative to the teeth. The marking, placing, grinding and flossing procedure is continued until the restoration seats comfortably in the mouth, with the contact areas being in the proper location, of proper size and with the proper tension against the adjacent tooth when the restoration is fully seated. X-rays are often taken to inspect if the restoration is fully seated on the preparation, but X-rays are an imperfect means of inspecting seating. The methods for testing occlusal fit are essentially similar. The dentist asks the patient to bite on or chew articulating paper, which marks the occluding surfaces of the restoration and the opposing teeth, which marks indicate where to make grinding adjustments. When the restoration has been adjusted into proper proximal and occluding contact, the dentist affixes the restoration to the underlying tooth with strong dental cement.

Current methods for testing proximal and occlusal fit at chairside are deficient. First, where the restoration cannot be seated between two proximal teeth because the space is too narrow, the direct try-in marks both sides of the restoration. These marks are ambiguous. They do not indicate whether only one side needs adjustment or whether both sides need adjustment. Further, if only one side needs adjustment, current methods do not reliably indicate to the dentist which is the side that must be adjusted and which is the side that must not be adjusted. If grinding adjustments are made to the wrong side of the restoration—or if they are made to the faces of the restoration in the wrong proportion—unacceptable gaps can be left between teeth and their marginal ridges, because it causes the restoration to seat improperly. Improper seating causes the dentist to make incorrect and unnecessary adjustments to the occluding surfaces of the restoration, and it causes small cement-filled gaps to be left beneath the restoration and the prepared tooth that are susceptible to wear and decay. Also, unnecessary adjustments can create gaps between teeth, which allow biting forces to impact food there.

Poor proximal fit is a serious problem. Food impacted in gaps in the proximal area by biting forces encourages the buildup of decay-causing plaque and causes instability and undesirable tooth movement. Plaque leads to premature crown replacement, tooth decay, gum disease, bone and tissue infection, loosened teeth, and tooth loss. Tooth movement can interfere with occlusal balance and therefore joint harmony. Tooth movement may cause joint inflammation and extreme discomfort. A gap in a restoration's seating allows the affixing cement to wear away, making the tooth vulnerable to decay, the gums vulnerable to disease, and the restoration susceptible to accidental or spontaneous removal. Further, when a dentist is forced to return bad-fitting restorations to the laboratory for adjustment or rework, the dentist, laboratory and patient incur additional cost and time, and each of them endures a repeat of the entire process they have been through to date, with no guarantee that the next results will be any better. In particular, the patient can suffer the effects of additional anesthesia, as well as inconvenience, discomfort and heightened tooth sensitivity from the continuing temporary restoration.

These problems are not rare or isolated. Millions of restorations a year are returned to dental laboratories for adjustment or remanufacture, usually because of poor fit. An unknowable number of times, but probably in millions of cases, the dentist cements a less-than-optimally-fitting restoration into the patient's mouth and hopes for the best, forcing the patient to suffer the consequences for the lifetime of the restoration.

Not only are inaccurate restorations problematic, the adjustment process itself is unpleasant. The patient suffers stress, pain and discomfort as the restoration is forced on and off the sensitive prepared tooth. To minimize this stress and pain, dentists often must use anesthesia which compromises the accuracy of the feedback the patient can give. As a result, serious occlusion problems may not be discovered until hours later, thereby requiring emergency off-hours treatment. The dentist endures poor working conditions as well, such as sub-optimal lighting, insufficient magnification, limited ability to apply force, poor visibility, the risk of contracting or transmitting blood-borne, salivaborne or breath-borne illnesses, the need to wear gloves, and the necessity of working in small, semi-enclosed, hot, wet, bacteria-filled space with limited, difficult and uncomfortable angles of access to the restoration site. Further, the dentist can only use marking substances having toxicity, taste, and temperature characteristics the mouth can endure. Also, proper seating of the restoration on the preparation is hard to ascertain in the mouth, and it is difficult to tell whether a crown is well seated or rather simply appears to fully seat because of pressure against its adjacent tooth or because it is hung up on an internal ridge. It is often necessary to take x-rays to inspect the restoration's seating. Patients often manipulate their cheek, tongue or jaw during adjustments, which can interfere with the adjustment process. Restorations occasionally fall into the patient's throat during adjustments and are swallowed, making retrieval unpleasant. The entire adjustment process makes a bad impression on the patient, and the patient is likely to blame the dentist for failing to make a perfect-fitting restoration in the first instance.

Current methods for producing dental cast models are also deficient. Dentists and dental laboratories routinely use dental stones or plasters to mount and make teeth models. The most commonly used dental stones take hours to cure. These materials also expand over time as they fully cure, which tends to introduce inaccuracies. It is difficult to control the curing process and manipulate the stone. Moreover, manipulation during use causes parts of the model to rub against other parts of the model, which abrades material. This means that after the first corrective grinding is made, the abrasive wear introduces inaccuracies, giving the dentist an incorrect record guide for further adjustments. These abrasions either create voids where the mock tooth structure should be maintained or put debris into the mechanisms (such as tapered holes) that otherwise would maintain the proper alignment of the tooth model segments.

Further, for the reasons explained above, it is customary to cut the model into sections that allow teeth to be selectively removed. This process generates debris that can enter the die pinhole or the space between the die and its mount and disturb seating. As a result of these cutting and abrasion issues, many dentists require their laboratories to pour up two models from the impression—a sectional model and a solid model—so that the crown can be tested on a non-sectioned model. This wastes material and time. Dental laboratories use expensive vacuum systems to facilitate the removal of most of the debris.

Moreover, dental stones and plasters require the user's time, trouble and skill in their mixture and application. They require replacement for each new case. They are messy. They contain hazardous substances that can induce silicosis in persons coming into regular contact with them. They produce a substantial amount of waste product. They require spatulas, water graduates, a mixing bowl, and their clean-up. The process of creating a dental cast model with dental stone is cumbersome and time consuming.

Some laboratories try to overcome these deficiencies by using epoxies or similar plastics to make a model. A good example is disclosed in U.S. Pat. No. 5,911,580 entitled Method for Preparing Dental Models. While this is an improvement from dental stone, it is difficult to control the curing of these self-cure materials. These materials are difficult to prepare and use, are sometimes impossible to manipulate prior to and during setting, have substantial shrinkage, and are relatively expensive. They take a material amount of time to cure.

Dentists currently use alginates and similar materials mounted on trays to take impressions. These materials are accurate, but they self-cure over the span of a few minutes. Consequently, it is common for the patient to manipulate their jaws, tongue or cheeks during curing in a manner that distorts the impression. This distortion is usually not discovered until much later, after the restoration has been made to incorrect specifications and is useless. They are very viscous when mixed and initially applied, making them difficult to control. Given the bulk and texture of the impression material, the impression experience is unpleasant for many patients.

Some dentists minimize tooth drift and laboratory error by using machines that cut an all-porcelain restoration that can be seated at the initial appointment. These machines sometimes do not achieve a good occlusal fit. Further, the all-porcelain restorations it produces are more fragile than typical porcelain-fused-to-metal (PFM) restorations; consequently, they are subject to fracturing upon occlusion testing and seating. These machines cannot be used to create metal crowns (e.g., gold), or PFM crowns. Cerec machines are very expensive and complex.

When a restoration does not fit, a dentist will often take new impressions and send the crown back to his dental laboratory. The dental laboratory produces a new stone cast model for adjustments. This method gives the teeth additional opportunity to shift, unless the dentist has an on-site laboratory dedicated to his work thereby providing same-day turnaround. It usually requires a new seating appointment. It requires the dentist to take a new set of impressions that is unpleasant for the patient and troublesome for the dentist. Further, the process of creating an accurate cast model is labor intensive, time consuming, and technique-sensitive. Finally, it typically requires the dentist to put a new temporary crown on the patient, with all the attendant difficulties.

A need exists, therefore, for a method and device that allows for adjustments to be made to restorations outside of the patient's mouth, avoiding the limitations and burdens inherent in current methods.

### BRIEF SUMMARY OF THE INVENTION

The subject invention is an articulator for making and adjusting a dental restoration and a method of using the same. The articulator of the subject invention comprises a laboratory die and a proximal counter. In an alterative embodiment, the articulator comprises a laboratory die and a minimalist model. The minimalist model comprises the proximal counter and an occlusal counter. In yet another alternative embodiment, the articulator comprises a laboratory die and an occlusal counter.

The laboratory die and minimalist model are positioned in operative relation for making and adjusting a dental restoration. The laboratory die and the proximal counter may also be used in a position that is in operative relation for adjusting the dental restoration. The proximal counter is utilized for adjusting the restoration's fit with the proximal teeth or the proximal contacts. The occlusal counter is utilized for the adjusting the way in which the restoration and opposite teeth fit together when the patient bites or chews, otherwise known as the occlusion.

A key advantage of the subject invention is the accurate and external oral (extraoral) adjustment of a restoration's proximal contacts and occlusion on an adjustment model, before the teeth have an opportunity to shift. Extraoral adjustments are performed by using an adjustment model to mark the restoration, as opposed to directly using the patient's anatomy to generate the marks. An adjustment model is a dental model to be used shortly after its manufacture, remanufacture, or alteration for purposes of adjusting a restoration to the patient's present-time anatomy, as represented in the model. By avoiding internal or intraoral adjustment, obtaining full seating and passive contacts is easy, painfree and fast. Using the present invention, the practitioner has essentially converted the patient's mouth into a sectional model which allows the representations of the proximal teeth to be selectively removed and replaced when performing the usual marking and adjusting procedure.

In contrast, when the restoration is adjusted via placing it directly within the patient's mouth (intra-orally), both sides of the crown are marked, even if only one side requires adjustment. It is also difficult to know whether the restoration is fully seated in the mouth or simply sandwiched between the proximal teeth with contact area pressure. Extraoral adjustments eliminate this intraoral ambiguity by enabling the virtual extraction and replacement of interfering proximal teeth. The need to take x-rays to confirm seating is minimized, as visibility at the margins is enhanced. Use of a sectional model results in no unnecessary proximal adjustments or sandwiching problems. Full seating is also easier to confirm on a sectional model.

By eliminating the presence and movement of cheeks, tongue and jaw, as well as the impingement of gingival tissue, the present invention offers excellent visibility, access, ease of use and accuracy. Extraoral adjustments enable the dentist or his auxiliary to avoid, or minimize the need for, the following difficulties normal associated with the adjustment process: taking x-rays to confirm seating, injecting feedback-compromising anesthesia, chipping porcelain during restoration seating or removal or occlusion testing, adjusting other teeth, and patient stress. By eliminating the patient and his saliva from the adjustment process, it enables the dentist or auxiliary to work without gloves, reduces the risk of transmitting disease to or from the patient, and makes articulating paper marks easier to read. The ease of use, relative technique insensitivity, and extraoral nature of the invention facilitate the dentist's delegation of the adjustment process to the dental assistant from a legal, ethical and practical perspective. This delegation in turn should benefit the dentist, patient and laboratory by reducing the number of laboratory reworks and additional seating appointments required, since it gives the dentist an incentive to fix the problem during the first seating appointment, rather than send the restoration back to the laboratory. Extraoral adjustments also make a good impression on the patient, since the patient will never see how badly the crown was out of adjustment or how much time it took to make the necessary corrections. The dentist can also use marking substances having nearly any toxicity, taste, and temperature characteristics.

In addition, the use of the interproximal impression and a minimalist model (a model comprising a proximal counter and/or an optional occlusal counter) for producing the adjustment model facilitates the employment of expensive materials having superior characteristics. For example, using small amounts of material such as light-cure composite as a modeling material provides greater control over the curing process and material placement, since they are not self-curing. Light-cure composite cures very quickly, is less viscous than standard impression materials and dental stone, and is easy to manipulate. It minimizes material waste. It is faster than using dental stones and plasters. It makes cleanup easier. The materials are quicker and easier to use and prepare.

Further, substituting composites or acrylics for stones and plaster in dental models minimizes the inaccuracies that abrasion, debris and dental stone expansion introduce. It reduces silicosis risk to workers. It eliminates the need to use vacuum systems for stone debris removal and facilitates clean-up. The models are easier to make and handle. The materials are more pleasant for dentists, patients and laboratory technicians to work with.

The present invention has several advantages over conventional dental cast models, both for adjustment purposes and fabrication purposes. First, in the case of fabrication models (i.e., a dental cast model used initially to fabricate a crown), the present invention's functional elements are separately cured onto pre-sectioned metal parts. This eliminates the time, trouble and debris normally associated with the sectioning process. It causes less clinically significant expansion or shrinking than that which would normally occur when a larger mass of material is cured. Most importantly, it facilitates the cannibalization of the die of the prepared tooth (herein also referred to as the laboratory die or the preparation die) from the fabrication model into the adjustment model.

Second, the alignment of the sectioned elements is precisely maintained under great clamping force. This helps to crumble debris caught between the clamped sectioned elements that might otherwise interfere with accurate alignment. It enhances the rigidity of the functional elements by eliminating the “play” that might otherwise exist between passively sectioned elements of the model.

Third, fabricating each of the preformed parts of the sectioned elements completely from metal having high strength helps them to resist the forces applied to them during use. It enhances the durability, life and beauty of the invention. It enables the consistent accuracy that precision machining can provide. It eliminates the inaccuracy-inducing debris and expansion that are traditionally generated by alignment means within a cast model formed in part or in whole from stone.

Fourth, vertical alignment of the counters is maintained by smooth, flat metal surfaces surrounding the area where the “pin” enters the base, and not the pin itself. Further, the bottomless, non-tapered pin-hole design minimizes the risk that debris will disturb alignment for two reasons: (a) most debris falls through the hole and (b) any material retained in the hole that might disturb alignment is pushed out upon inserting the pin or crushed to clinical insignificance upon clamping it into position. Further, the smooth, polished surface surrounding the pin area (as well as the smooth, polished surface forming the bottom of its opposing member) is easy to wipe or blow clean. This simple alignment means reduces manufacturing costs, and makes model making faster and less technique-sensitive.

Fifth, the invention enables the user to rotate the proximal segments in and out of position, which is convenient.

Sixth, the invention may employ screws instead of tapered pins for its disposable elements. Screws are less expensive, simpler and more widely available than the tapered die-pins that are traditionally employed in dental models. They are commercially available in a wide variety of designs and sizes that offer varying characteristics that aid placement, insertion, and modeling-material retention. The screw's threads help lock in the modeling material, inhibit rotation and facilitate the locking of the screw into its non-disposable element. Tapped screw holes are simple to machine, reinforce and repair.

Seventh, the present invention employs a fixed laboratory die. This facilitates the cannibalization of the die from the cast fabrication model to the adjustment model.

Eighth, the subject invention uses the laboratory die as the preparation die for the adjustment model. This recycling of the laboratory die for the adjustment model ensures that the restoration will be well mated to the adjustment preparation die. It eliminates the need to use dental stones to pour up a new adjustment preparation die, thereby speeding up the process and making that process easier and cleaner.

Further objects and advantages of the invention will become apparent from the preceding and a consideration of the drawings and ensuing description.

### BRIEF DESCRIPTION OF THE DRAWINGS

FIG. 1 is a perspective view of a preferred embodiment of the articulator of the subject invention depicting a proximal attachment as used to adjust a dental restoration.

FIG. 2 is a perspective view of a preferred embodiment the articulator of the subject invention depicting an occlusal attachment as used to adjust a dental restoration.

FIG. 3a is the front view of the articulator with the proximal attachment

FIG. 3b is a side view of the articulator with the proximal attachment.

FIG. 4a is a front view of the articulator with the occlusal attachment.

FIG. 4b is side view of the articulator with the occlusal attachment.

FIG. 5 is a cross-sectional view of the articulator with the proximal attachment.

FIG. 7 is a cross-sectional view of the articulator with the occlusal attachment.

FIG. 8 is a cross-sectional view of the articulator as used to fabricate a dental restoration.

FIG. 9a is a cross-sectional view of a dental restoration as seated on a laboratory die and positioned with the proximal counter for adjusting with dental restoration.

FIG. 9b is a cross-sectional view of a dental restoration as seated on a laboratory die and positioned with the occlusal counter for adjusting the dental restoration.

FIG. 10 is an exploded view of a dental restoration as positioned on a laboratory die.

FIG. 11 is a cross-sectional view of the base of the articulator showing the laboratory die affixed into stone casing in the well.

FIG. 12 is a cross-sectional view of the base of the articulator showing the laboratory die affixed by a clamp.

FIG. 13a is a front view of the proximal anchor.

FIG. 13b is a side view of the proximal anchor.

FIG. 14a is a cross-sectional view of the proximal anchor cut along line 14a of FIG. 13a.

FIG. 14b is a cross-sectional view of the proximal anchor along line 14b of FIG. 13b.

FIG. 15a is a front view of the occlusal attachment.

FIG. 15b is a side view of the occlusal attachment.

FIG. 16a is a cross-sectional view of the occlusal attachment along line 16a of FIG. 15a.

FIG. 16b is a cross-sectional view of the occlusal attachment alone line 16b of FIG. 15b.

FIG. 17 is a cross-sectional view of one preferred embodiment of the clamp of the subject invention.

### DETAILED DESCRIPTION OF THE INVENTION

The subject invention is an articulator for making and adjusting a dental restoration and a method of using the same. The articulator of the subject invention comprises a laboratory die and a proximal counter. In an alternative embodiment, the articulator comprises a laboratory die and an occlusal counter. In yet another an alterative embodiment, the articulator comprises a laboratory die and a minimalist model. The minimalist model comprises the proximal counter and an occlusal counter.

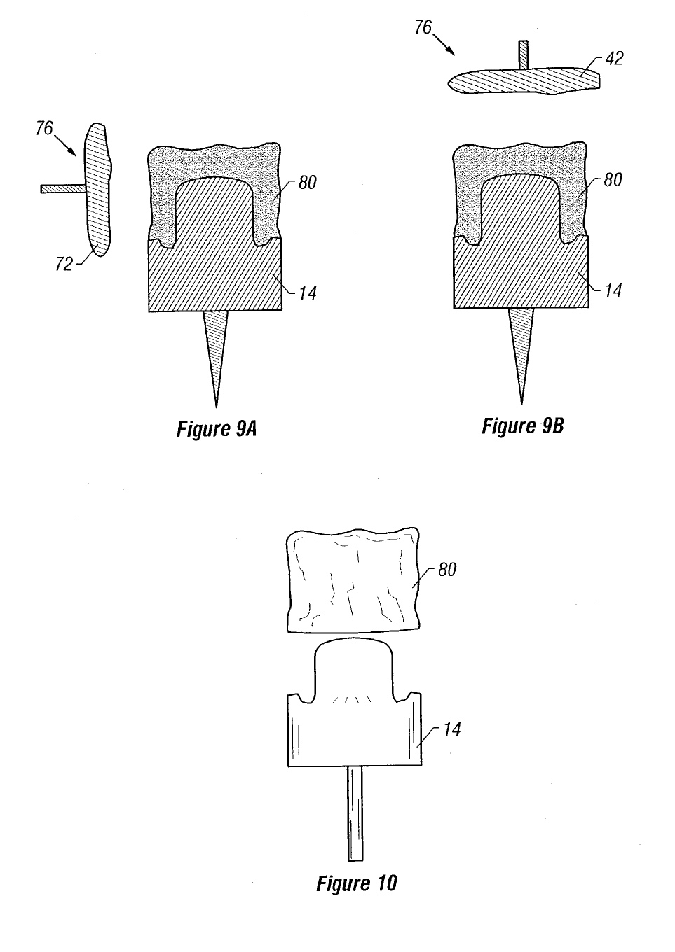

The device of the subject invention is an articulator 76 comprising a laboratory die 14 and a minimalist model 78. The laboratory die 14 is a dental model of the prepared tooth or teeth from which a dental restoration is made. The laboratory die 14 is a dental model of the prepared tooth, teeth, gums, denture, implant, and/or other structures on which a dental restoration is seated. Dental restorations suitable for use in connection with the subject invention include, but are not limited to, a crown, implant crown, bridge, inlay, onlay, denture, anterior veneer facing and other similar dental restoration products. As shown in FIG. 10, the dental restoration 80 is made from the laboratory die 14.

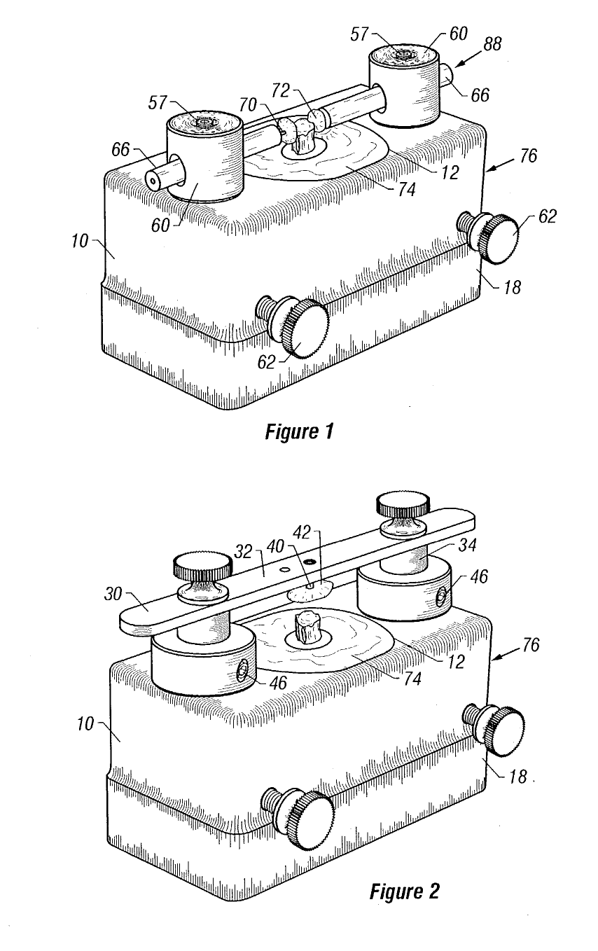

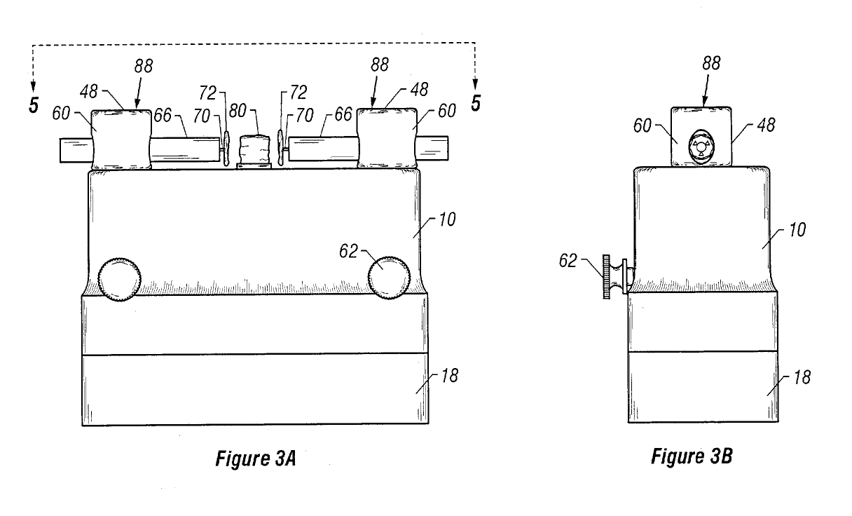

In a first preferred embodiment of the invention, shown in FIGS. 1, 3a, 3b, 5, 7 and 9a, the minimalist model 78 is a proximal counter 72 operatively positioned from the laboratory die for adjusting a dental restoration 80. In a second preferred embodiment of the invention, as shown in FIGS. 2, 4a, 4b, 6, and 9b, the minimalist model 78 also has an occlusal counter 42. When the proximal counter 72 and the occlusal counter 42 are both used together, both the proximal surfaces and occlusion of the dental restoration may be adjusted using the articulator 76. The proximal counter 72 represents the current proximal tooth surface of a patient. Similarly, the occlusal counter 42 represents either the functional bite path or centric bite.

To make the proximal counter 72 and the occlusal counter 42, an interproximal impression may be utilized. Other methods for making the proximal counter 72 and the occlusal counter 42 are available. For example, an ordinary cast model could be made with the part comprising the counter removed and the part not comprising the counter discarded. However, use of an interproximal impression (not shown) as described herein is preferred. The interproximal impression registers the present-time dimensions of the anatomy and, if made from a rigid material such as composite or acrylic, can register the patient's functional bite path. Adjustments of the dental restoration 80 are made on the minimalist model as opposed to repeated attempts to fit the restoration 80 to the patient's mouth.

The interproximal impression (not shown) could be made in a variety of ways, but the preferred method is as follows. First, the patient's temporary crown is removed and the preparation is cleaned. An impression material, preferably a polyvinylsiloxane, is injected all around the preparation, and the patient bites into it until it cures. Then, this impression is removed, trimmed to remove flash, disinfected if desired, and dried. The impression is ready to be mounted on laboratory die 14. If this method of making the interproximal impression has been used, the user must first remove any die spacer on laboratory die 14 by soaking it in acetone, methyl ethyl ketone or another paint stripper for a time, rinsing off the residue, and drying it. The user can accelerate the removal of die spacer while the laboratory die 14 is soaking by placing the container in an ultrasonic cleaner. Alternatively, a composite or acrylic coping made from laboratory die 14 can be used to make the interproximal impression. The coping (not shown) would provide a stable base for taking a functional bite impression in the mouth using additional composite or acrylic. If composite has been used to make the interproximal impression, a separating medium such as petroleum jelly would have to be used when building out the adjustment model, as described below.

To make the proximal counter 72 from the interproximal impression, the interproximal impression is cleared of any flash or other obstruction that would prevent the proximal counter mount 70 from reaching to the contact areas of the interproximal impression. This step will usually be unnecessary.

A first small ball of composite material (not shown) is pressed into the spacing of the interproximal impression representing the proximal contours of the proximal teeth. Preferably, flowable composite is used, although nearly any composite, acrylic or dental stone will work if properly handled. Alternate materials that could be used in place of composite material include glass ionomer, plastic, thermoplastic, custom tray material, acrylic, dental compound, dental stone or plaster, silicate, amalgam or mollott's metal.

The interproximal impression is placed on the laboratory die 14. A second small ball of composite material (not shown) is tightly packed or flowed around the proximal counter mount 70. As described below, the proximal counter mount 70 is aligned and locked into place to prevent movement.

With a finger, the interproximal impression is held immobile. The second uncured composite material covering proximal counter mount 70 is positioned in contact with the first uncured composite material within the proximal contours of the interproximal impression. Alternatively the proximal counter 72 could be formed directly on the proximal counter mount 70 without applying the first uncured composite material to the interproximal impression. The proximal counter mount 70 need not point directly at the contact area or be in close proximity to it, although it is preferable. The composite is light-cured or allowed to self-cure, depending on the material used.

The same steps are repeated to create the proximal counter on the other side of the interproximal impression. As an alternative, each proximal counter 72 could be first cured and then affixed to a proximal counter-mount 70 with an adhesive such as cyanoacrylate. As an alternative to forming the proximal counters from modeling material such as composites or acrylics, preformed structures that approximate the typical size and shape of the contact area for the contact being adjusted could be placed in proper alignment with the interproximal impression

Following the curing of the composite, the interproximal impression is removed from the laboratory die 14. The dental restoration's proximal contacts may now be adjusted in a manner similar to that used with a sectional stone model.

To make the occlusal counter, a third small ball of composite material (not shown) is pressed or flowed into the occlusal surface of the interproximal impression. Any suitable modeling material such as acrylic, dental stone, epoxies, etc. may be used to form occlusal counter 42. The interproximal impression is placed on the laboratory die 14. A fourth small ball of composite material (not shown) is tightly packed or flowed around the occlusal counter mount 40. The fourth uncured composite material covering occlusal counter mount 40 is positioned in contact with the third uncured composite material within the occlusion area of the interproximal impression. As described below, the occlusal counter mount 40 is aligned and locked into place using the shaft collars surrounding the legs of the occlusal member. Since the occlusal counter 42 is much larger than the proximal counter 72, multiple counter-mounts or an oversized counter-mount may be utilized. The occlusal counter 42 is cured or allowed to self-cure, as the case may be, and then the interproximal impression is removed.

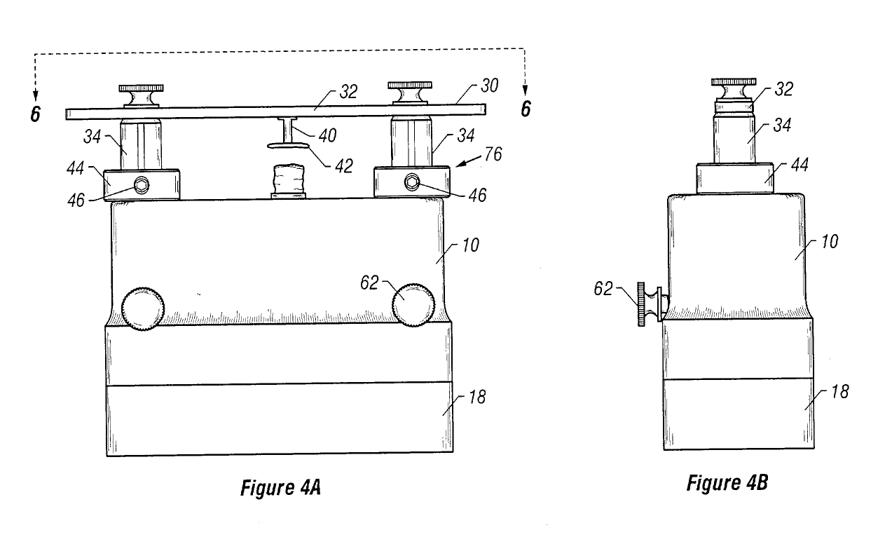

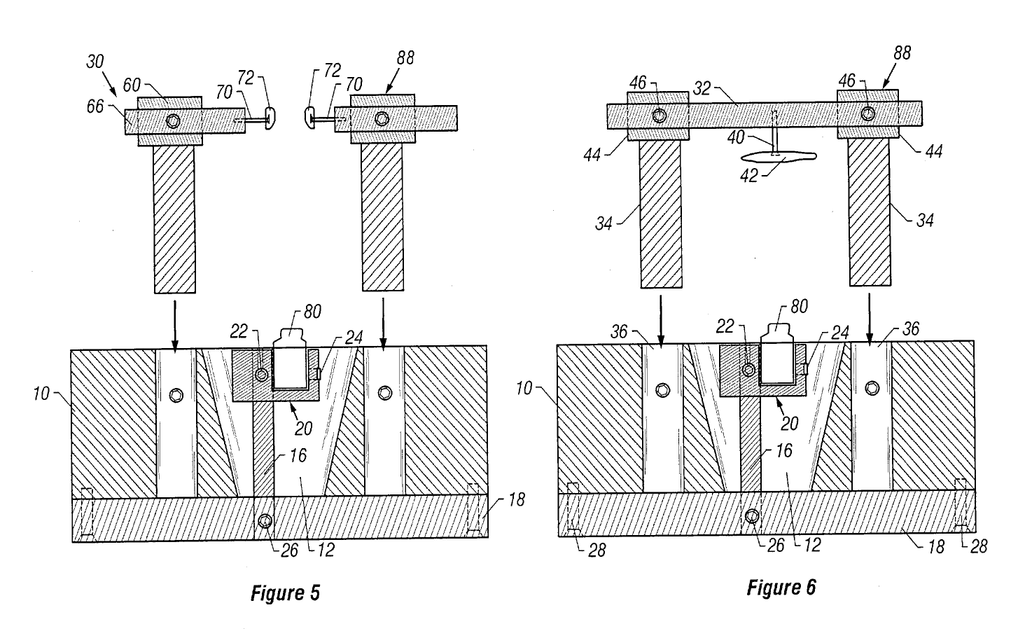

As shown in FIGS. 1 through 7, a preferred articulator 76 of the subject invention utilizes a base 10 wherein said laboratory die 14 is affixed in said base 10. The laboratory die 14 may be affixed in the base 10 by a variety of ways well known to those skilled in the art. FIGS. 4 and 5 respectively, depict a stone casing 74 and a clamp 20 that affix the laboratory die 14 into position. Alternatively, cyanoacrylate, other adhesives, composite, epoxies, plastics, impression materials, other modeling materials, screws, die pins, other pins, joints, locks, or retentive forms may be used to affix the laboratory die 14 into position.

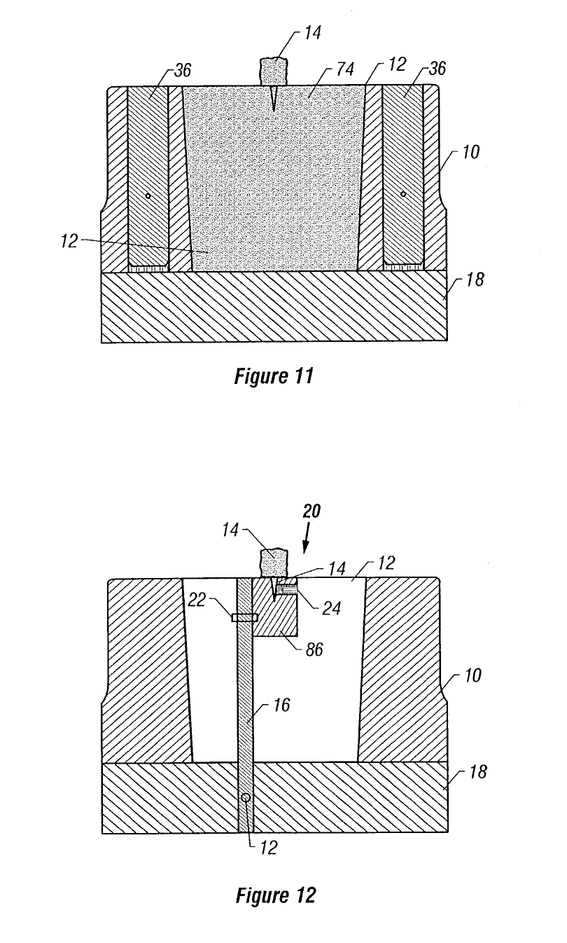

To prepare the stone casing shown in FIGS. 1, 2, 11 and 12, the interior of the well 12 should be lubricated with petroleum jelly or a silicone-based lubricant. In addition, a few sheets of paper such as nasal tissue may be placed in the bottom of the well 12 for cleanliness and to ensure that the stone or plaster casing will fit tightly in the base 10 after the stone or other material expands during setting. Fast-setting dental stone is recommended for convenience. However, the casing 74 could also be made from plaster, duralon, dental compound, acrylic, composite, lead compound, hard stickywax, hand wax, zinc oxyphosphate cement, composite, silicon putty, silicate substance, glass ionomer, epoxy, lead or mollott's metal, or any other semi-liquid material that cures to a hard state.

Note that the shape and size of the well 12 are relatively immaterial, but it should be deep enough fit any length of die and die pin in general use by dental laboratories. The well 12 should be wide enough to accommodate the laboratory die 14 suspended from its center at a moderately oblique angle, since not all laboratory die pins are perpendicular to the occlusal plane.

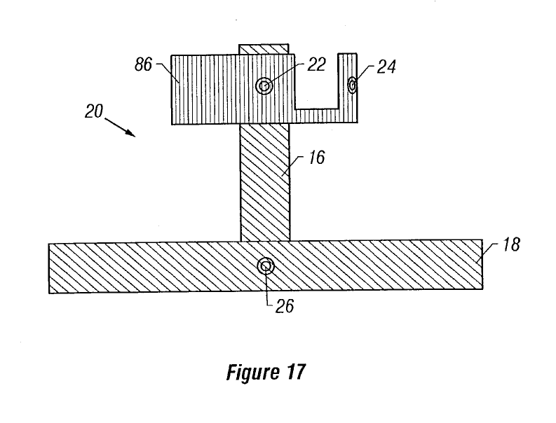

As shown in FIG. 17, a preferred clamp 20 comprises a clamp shaft 16, clamp top 86, and a die clamp set screw 24. The die clamp set screw 24 secures the laboratory die 14 in position on the clamp top 86, either by clamping onto the stone portion of the die or the metal die pin, and allows the clamp top 86 to lowered or raised on clamp shaft 16 as desired. A clamp shaft set screw 22 attaches the clamp shaft 16 to the clamp top 86. A platform clamp set screw 26 attaches the clamp shaft 16 to base 10 or, as shown, the optional platform 18 holding the clamp 20 into position. Alternatively, clamp top 86 could be made with a tapered hole on its superior surface which mates to the tapered die pin used in laboratory die 14.

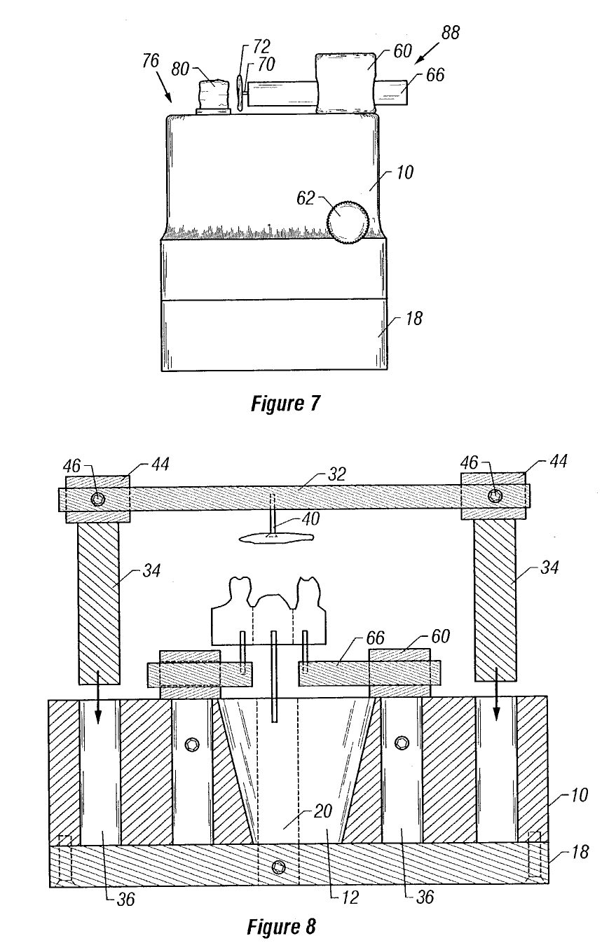

In the preferred embodiment, the articulator 76 also comprises at least one proximal attachment 88 and an occlusal attachment 30. As shown in the Figures, the proximal attachment 88 and the occlusal attachment 30 are interchangeable as positioned in the base 10 of the articulator 76. As shown in the figures, the base 10 is preferably made to hold two proximal attachments 88 that are removed and replaced with one occlusal attachment 30 at the appropriate time. However, only one proximal counter 72 is necessary to practice the subject invention, which is depicted in FIG. 7. In that event, the occlusal attachment 30 aligns along its front-back axis, although it could be aligned in any horizontal direction using new shaft holes, so long as the positioning allows the occlusal counter 42 to be vertically lowered into its proper relationship.

The occlusal attachment 30 and the proximal attachment 88 could be maintained in proper rotational alignment by methods well known to those in the art, such as (i) a vertically mounted locating pin attached thereto which penetrates in the base when the subject attachment is inserted, (ii) an irregularly shaped occlusal shaft 34 with a mated attachment shape, or (iii) a traditional pin-and-sleeve mechanism. With the one proximal counter 72 design, the stone casing 74, clamp 20 or the laboratory die would simply be rotated 180° and a new proximal counter 72 representing the proximally opposite tooth would be made. This method is particularly useful when working with very large restorations, such as a five-unit bridge, which would not fit within the well 12.

In one preferred embodiment and as shown in detail in FIGS. 1, 3a, 3b, and 5, the proximal attachment 88 comprises a proximal anchor 48 and a proximal cross pin 66 for holding the proximal counter 72. As shown in the Figure, a proximal cross pin 66 may be removeably connected to a proximal anchor 48. Preferably, the proximal cross pin 66 slides through the proximal anchor 48 for easy removal and the precise positioning of the proximal counter mount 70. The proximal counter mount 70 removeably attaches to a proximal cross pin 66. Alternately, the proximal attachment 88 may be positioned using: (i) a projector slide-box arrangement, whereas ridged sides of proximal attachment 88 slide into mating slots which permit the proximal attachment 88 to be inserted at discrete intervals, (ii) a hinged design that allows proximal attachment 88 to swing up and be locked into position and the hinge point to be relocated to various points along the base, or (iii) a spiral galaxy pattern of nearly-circular shaft holes 36 arranged around the well that allow a fixed anchor to be placed in hole-pairs that are set opposite the well 12 at the appropriate distance, or other methods known to those skilled in the art.

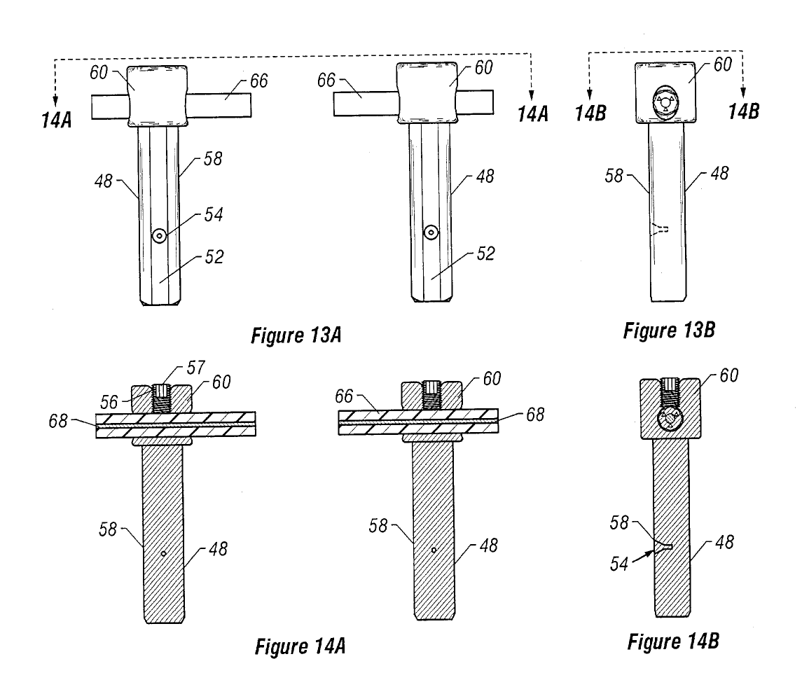

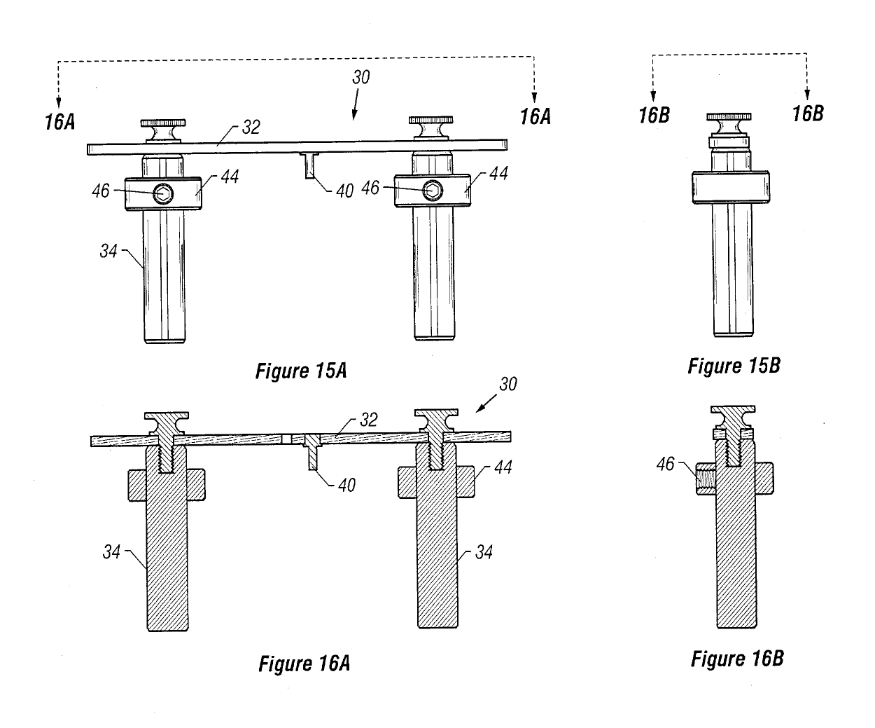

As show in FIGS. 13a, 13b, 14a, and 14b, the proximal anchor 48 has a proximal head 60 and a proximal shaft 58 having a flat surface 52 and a proximal cross hole 54. The proximal head 60 has an axial set screw hole 56 located in the top of the head 60. The proximal head 60 and the proximal shaft 58 may be made as a single unit or may be separate pieces. A proximal axial set screw 57 is placed into the axial set screw hole 56 to lock the cross pin 66. Alternatively the cross-pin 66 is slideably connected and affixed to the anchor 48 by methods and devices well known to one skill in the art such as a precision pin penetrating both the cross-pin 66 and the proximal head 60, adhesive, a screw with a series of mated holes in the cross-pin 66, or a strong magnet. Instead of using the cross-pin 66, the dentist could select from a series of proximal attachments having an integral cross-pin-like structure, each having an integral cross-pin-like structure of a differing length.

In the preferred embodiment and as shown, the proximal counter mount 70 is removeably connected to a proximal cross pin 66. However, the mount 70 can be part of, or integral with, the cross pin 66.

With the proximal anchor 48 having at least one flat surface 52, air is allowed to escape when the proximal anchor 48 is inserted and removed. Because proximal anchor 48 slides mostly down an open shaft hole 36, debris falls through without impeding its function. The proximal cross hole 54 preferably is cone shaped with convex walls to assist in maintaining alignment of the proximal anchor 48 as it wears over time. The proximal anchor 48 is locked into position with a proximal anchor screw 62. Rotation of the proximal anchor 48 is prevented by use of an anti-rotational set screw (not shown) that fits into the proximal cross hole 54. However, alternative ways of preventing rotation of the proximal anchor 48 and ensuring its replacement in a consistent position are available and well known to those skilled in the art such as: (i) changing the shape of proximal anchor 48 and shaft hole 36 to a non-circular irregular shape, (ii) penetrating proximal anchor 48 and base 10 with an alignment pin or screw, (iii) using alignment marks with a locking mechanism, (iii) making the bottom of proximal anchor 48 an irregular shape which fits into a mating hole, (iv) using strong magnets that mate up with appropriately magnetized parts of the proximal anchor 48, (v) passing a current around the circumference of the proximal anchor 48 and using a rheostat incorporated within the base to measure when consistent positioning is maintained, or (vi) placing mating alignment marks around the circumference of the proximal head 60 and the lip of shaft hole 36. Following the curing of the proximal counter 72, the proximal anchor screw 62 is unlocked and the proximal counter 72 and the interproximal impression removed from the laboratory die 14. As an alternative to forming proximal counter 72 from composite or another modeling material, it could be prefabricated from metal in a shape that approximates the typical contact area anatomy for the type of proximal tooth represented by the proximal counter 72.

As shown in FIGS. 2, 4a, 4b, 6, 16a, and 16b, in a preferred embodiment, the occlusal attachment 30 comprises an occlusal bar 32, an occlusal shaft 34, and an occlusal counter mount 40. The occlusal counter mount 40 attaches to the occlusal bar 32 for preparing the occlusal counter 42. The occlusal shaft 34 has a shaft collar 44 and shaft hole 36 for receiving a shaft collar set screw 46. The occlusal bar 32 is positioned in the occlusal shaft 34 at the desired level of tension. The shaft collar 44 limits the downward motion of occlusal shaft 34, thereby preventing the occlusal counter 42 from dropping below the area representing the downward limit of the teeth in the opposing arch. As mentioned above, before separating the interproximal impression from the occlusal counter 42, the height set by the interproximal impression is locked into place. To do this, the shaft collar 44 of the occlusal attachment 30 is locked into place by the shaft set screw 46.

To adjust a restoration, prepare the proximal counter 72 and occlusal counter 42 as described above. The laboratory die 14 is rigidly held in place preferably on the base 10 in any one of the methods described here or generally known to one skilled in the art. For example, the laboratory die 14 maybe clamped into place or placed into the well 12 containing stone or other suitable material. Clamping is most convenient for single-unit restorations, whereas stone or plaster is best for bridges. The laboratory die 14 should be aligned so that its proximal contacts are approximately facing the ends of the cross pins 66.

When luted to the laboratory die 14, the restoration itself can be used as an aid to hang the laboratory die 14 in the appropriate position. If a stone well is to be used, wax or similar substance may be placed on top of the restoration that is luted to the laboratory die 14 and over the cross pin 66 to ensure that the laboratory die 14 does not sink into the setting stone. Any mild adhesive should suffice for these purposes. If a quick-set dental stone is used, the laboratory die 14 can be held in place with one's fingers for approximately fifteen seconds, until the stone is sufficiently set.

If the laboratory die 14 is to be clamped into place, first place the laboratory die 14 on the clamp top 86. The laboratory die 14 is locked into place with the die clamp set screw 24, taking care not to pulverize or crack the laboratory die 14. Alternatively, laboratory die 14 can be locked into place by clamping onto its die pin. If desired, add locking substance such as cyanoacrylate in appropriate places to further render it immobile and as accelerator, if desired. A foam rubber or hard rubber insert can be mounted against or on the wall opposite the die clamp set screw 24 to inhibit rotation upon clamping and to accommodate non-parallel die walls. The laboratory die 14 should be tested for rigidity by applying manual pressure in several directions. The clamp shaft 16 may be affixed to the platform 18. The platform 18 may be permanently affixed or removeably attached to the base 10. The proximal surfaces of the laboratory die 14 should extend a predetermined distance above the top of the shaft 16, such that the proximal surface is aligned with the proximal counter mount 70 when the clamp 20 is affixed to the base 10. The base 10 is placed over the clamp 20 and onto the platform 18, if provided. The clamp 20 is then affixed to the base 10. In the FIGS. 5, 6 and 12, the platform set screw 26 affixes the clamp 20 to the base 10. In lieu of a clamp 20, one or more holes for receiving the laboratory die may be mounted in a base that lacks a well, with one or more set screws mounted in the wall of the base that will render the die immobile. Since die pins typically have a flat surface that might result in unwanted rotation upon clamping, the die pin of the laboratory die 14 could be sheathed in a mating cylindrical housing that could be inserted in the die holes of the modified base 10.

When the temporary restoration is removed, the patient's mouth is inspected for cement or gingival tissue that will interfere with the restoration and its marginal integrity. The tissue and cement are removed as required. The interproximal impression is made as described above.

The occlusal counter 42 and the occlusal bar 32 upon which it is mounted are used in essentially the same manner in which the VERTICULATOR® is used. After the interproximal impression is removed, the restoration 80 is seated on the laboratory die 14. Then the occlusal attachment 30 is inserted in the shaft holes 36. Articulating paper is placed over the occlusal surface of the restoration 80 and the occlusal attachment 30 is lowered. Alternatively, other marking substances could be directly applied to the restoration 80. The occlusal attachment 30 will mark the high spots on the restoration 80, which are then ground off with a drill. This procedure is repeated in an iterative process until the shaft collars 44 bottom out on the base 10 of the device. When the marking material fails to leave marks when the articulator bar is lowered and the shaft collars are heard clanging against the base 10, the restoration 80 is in hypo-occlusion by the thickness of the marking material or articulating paper. This hypo-occlusion helps provide desired cementing space to avoid a change in occlusion after cementation. The occlusal shafts 34 may be set to differing heights to permit only one to be rotated out of position, while the other remains partially inserted in the shaft hole 36.

A larger restoration such as a bridge can be adjusted in essentially the same way as a single-unit restoration, with a more complex structure (comprised of the two preparation dies luted together) taking the place of laboratory die 14. In this event, dental stone should be used to affix the structure in the well 12. Alternatively and preferably, the contacts and occlusion of each prepared tooth can be separately adjusted on the invention using each preparation laboratory die separately in the device, as taught above, and occlusal adjustments to the pontic would best be made intraorally. The practitioner would simply set the model up using one preparation die, adjust the relevant contact and occlusion for that tooth, then set it up with the other preparation die, and adjust the relevant contact and occlusion for that tooth.

This articulator 76 of the subject invention is particularly useful for adjusting restorations cut from a CEREC machine, since the invention minimizes the occlusal forces to which the restoration is subjected and captures the functional bite path of the opposing arch. An individual laboratory die 14 is made. The proximal and occlusal counters are made as described above, and adjustments are made as described above. Adjusting a Cerec restoration in this manner minimizes the possibility that occlusal forces generated by the patient during adjustments or in attempts to seat or remove the restoration will fracture the restoration.

As shown in FIG. 8, the present invention can be used to make a restoration, as well as adjust one. A triple-tray impression (not shown) is taken of the arch containing the patient's preparation. The method for making this is commonly known to one skilled in the art. A cast model of the arch is then made containing the preparation. When cured and separated from the impression, all teeth in the cast model are cut away except for the portion representing the preparation and each proximal tooth. A die pin hole is drilled on the underside of each tooth. The triple-tray impression is then used to create a stone cast model of the opposite arch. When cured and separated from the impression, all teeth but the ones opposite the laboratory die 14 are cut away and the remaining portion of the cast model is reinserted into the impression.

Three short lengths of bent threaded metal rod are screwed into the proximal counter mount hole 68 and the top axis of the clamp shaft 16. These proximal anchors 48 are locked into the base 10, as well as platform 18 and clamp shaft 16. The proximal cross pins 66 are held loose within proximal head 60 and are manually aligned to correspond to the die pin holes drilled into the cast model. Each of the free ends of the threaded rod are fully inserted in the die pin hole and affixed therein by cyanoacrylate or another means. The cross pin 66 are locked into place, and the proximal teeth representations are sectioned away to form the laboratory die 14. When sectioning away the proximal teeth representations, it is advisable to leave a small gap between the dies to allow alignment to be maintained by the proximal cross pin 66. The proximal anchors 48 are removed.

Then the triple-tray impression is placed on the laboratory die 14, which is still anchored within the base 10. The occlusal attachment 30 is inserted into the base 10 so that the bar stretches across the cast model of the opposing teeth that is contained within the triple tray impression. If the triple tray impression prevents the occlusal attachment 30 from fitting the base 10, then cut away the interfering parts of the triple tray impression. The stone model within the triple tray impression is affixed to the occlusal bar with cyanoacrylate or another adhesive. The shaft collars 44 are locked into position. The triple tray impression is separated from the occlusal attachment.

The proximal anchors 48 can now be used with the base 10 to fabricate the restoration in the same manner in which an ordinary sectional model would be used, which is well known to those skilled in the relevant art. The occlusal attachment 30 can be used in the same manner described above to refine the occlusion of the restoration through marking and grinding techniques that are well known in the art.

While this invention has been described with a reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

Although the preferred embodiments of the invention have been illustrated in the accompanying Drawings and described in the foregoing Detailed Description, it will also be understood that the invention is not limited to the embodiments disclosed, but is capable of numerous rearrangements, modifications and substitutions without departing from the spirit of the invention.

What is claimed:

1. An articulator comprising:
a laboratory die; and
a proximal counter wherein said laboratory die and the proximal counter are positioned for adjusting or making a restoration to proximal teeth.

2. An articulator comprising:
a laboratory die affixed in the articulator; and
a minimalist model having a proximal counter and an occlusal counter, wherein said laboratory die and said minimalist model is positioned for making or adjusting a dental restoration.

3. The articulator of claim 2, further comprising an interproximal impression wherein said interproximal impression is positioned onto said laboratory die to construct said minimalist model.

4. The articulator of claim 3, further comprising a coping positioned between said laboratory die and said interproximal impression.

5. The articulator of claim 2, further comprising a base wherein said laboratory die is affixed in said base.

6. The articulator of claim 5, further comprising a well positioned in said base.

7. The articulator of claim 6, wherein said well contains material suitable for affixing said laboratory die.

8. The articulator of claim 2, further comprising a clamp suitable for affixing said laboratory die.

9. The articulator of claim 2, wherein said occlusal counter and said proximal counter are interchangeable in said articulator.

10. The articulator of claim 2, further comprising an occlusal attachment wherein said occlusal counter is affixed to said occlusal attachment.

11. The articulator of claim 1 or 2, further comprising a proximal anchor wherein said proximal counter is affixed to said proximal anchor.

12. The articulator of claim 10, wherein said occlusal attachment is removably positioned in said base.

13. The articulator of claim 11, wherein said proximal anchor is removably positioned in said base.

14. The articulator of claim 12 further comprising an occlusal counter wherein said occlusal counter is interchangeable with said proximal counter in the articulator.

15. A method of adjusting a dental restoration using the articulator of claim 1 or claim 2.

16. A method of fabricating a dental restoration using the articulator of claim 1 or claim 2.

17. A method of adjusting a dental restoration comprising the steps of:
making a proximal counter;
aligning said proximal counter with said laboratory die;
positioning a dental restoration on a laboratory die; and
inspecting the dental restoration for correct proximal contact.

18. The method of adjusting a dental restoration of claim 17 further comprising the steps of making an occlusal counter and aligning said occlusal counter with said laboratory die.

19. A method of adjusting a dental restoration, comprising the steps of:
making an interproximal impression;
making a proximal counter from said interproximal impression; and
adjusting the dental restoration with said proximal counter.

20. A method of adjusting a dental restoration, comprising the steps of:
making an interproximal impression;
making an occlusal counter from said interproximal impression; and
adjusting the dental restoration with said occlusal counter.

21. A method of adjusting a dental restoration, comprising the steps of:
making an interproximal impression;
affixing said laboratory die in position;
positioning said interproximal impression on a laboratory die;
making a proximal counter from said interproximal impression;
adjusting the dental restoration from said proximal counter.

22. An articulator comprising:
a laboratory die; and
a occlusal counter wherein said laboratory die and the occlusal counter are positioned for adjusting a dental restoration.
